(19) United States
(12) Patent Application Publication
(10) Pub. No.: US 2025/0354831 A1
(43) Pub. Date: Nov. 20, 2025

(54) IDENTIFYING MULTIPLE DEVICES USED AND/OR WORN BY A PANELIST USING STEP DETECTIONS AND/OR COUNTS

(71) Applicant: The Nielsen Company (US), LLC, New York, NY (US)

(72) Inventors: Girish Khavasi, Lake Hiawatha, NJ (US); John Stavropoulos, Edison, NJ (US); Alexander Pavlovich Topchy, New Port Richey, FL (US)

(21) Appl. No.: 19/206,226

(22) Filed: May 13, 2025

Related U.S. Application Data
(60) Provisional application No. 63/647,334, filed on May 14, 2024.

(51) Int. Cl. G01C 22/00

(52) U.S. Cl. CPC G01C 22/006

(57) ABSTRACT

In one example, a method is described. The method includes receiving a first number of steps over a period of time corresponding to a first portable people meter (“PPM”) associated with a first panelist of a household and receiving a second number of steps over the period of time corresponding to a second PPM associated with a second panelist of the household. The method includes comparing the first number of steps and the second number of steps over the period of time; determining that the first number of steps of the first PPM and the second number of steps of the second PPM vary less than a tolerance threshold; and based on the first number of steps of the first PPM and the second number of steps of the second PPM varying less than the tolerance threshold, determining that duplicate wear of the first PPM and the second PPM occurred.

### CROSS-REFERENCE TO RELATED APPLICATION

This disclosure claims priority to U.S. Provisional Pat. App. No. 63/647,334, filed May 14, 2024, which is hereby incorporated herein by reference in its entirety.

### FIELD OF THE INVENTION

The present disclosure relates in general to determining compliance of panelists of an audience measurement entity (“AME”) and in particular, to using step detections and/or counts to determine if a panelist of the panelists of the AME is wearing multiple devices.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect a method is described. The method is for determining duplicate wear. The method includes receiving a first set of motion sensing data associated with a first portable people meter (“PPM”) associated with a first panelist of a household. The first set of motion sensing data includes a first number of steps over a period of time. The method also includes receiving a second set of motion sensing data associated with a second PPM associated with a second panelist of the household. The second set of motion sensing data includes a second number of steps over the period of time. The method also includes comparing the first number of steps and the second number of steps over the period of time; determining that the first number of steps of the first PPM and the second number of steps of the second PPM vary less than a tolerance threshold; and based on the first number of steps of the first PPM and the second number of steps of the second PPM varying less than the tolerance threshold, determining that duplicate wear of the first PPM and the second PPM occurred.

In one or more aspects, the method further includes flagging the duplicate wear over the period of time as non-compliant. The method can also include removing the household from a panel of an audience measurement entity after the determining that duplicate wear of the first PPM and the second PPM occurred. The first set of motion sensing data can be accelerometer data from the first PPM. The accelerometer data can include an acceleration signal curve over the period of time. Peaks of the acceleration signal curve can indicate physical activity, and the peaks can correspond to the first number of steps. The accelerometer data of the first PPM is sampled at a rate between 15 and 20 Hz.

In another aspect, a non-transitory computer-readable storage medium, having stored thereon program instructions that, upon execution by a processor, cause performance of operations is described. The operations include obtaining a first set of motion sensing data associated with a first portable people meter (“PPM”) associated with a first panelist of a household. The first set of motion sensing data includes a first number of steps over a period of time. The operations also include obtaining a second set of motion sensing data associated with a second PPM associated with a second panelist of the household. The second set of motion sensing data includes a second number of steps over the period of time. The operations further include comparing the first number of steps and the second number of steps over the period of time; determining that the first number of steps of the first PPM and the second number of steps of the second PPM vary less than a tolerance threshold; and based on the first number of steps of the first PPM and the second number of steps of the second PPM varying less than the tolerance threshold, determining that duplicate wear of the first PPM and the second PPM occurred.

In some aspects, the operations further include obtaining a first set of media identifying information from the first PPM over the period of time; and obtaining a second set of media identifying information from the second PPM over the period of time. The operations further can include removing at least one of the first set of media identifying information or the second set of media identifying information from crediting based on the determining that duplicate wear of the first PPM and the second PPM occurred. The second set of motion sensing data can be accelerometer data from the second PPM. The accelerometer data can include an acceleration signal curve over the period of time. The peaks of the acceleration signal curve can indicate physical activity, and the peaks can correspond to the second number of steps.

In another aspect, a computing system is described. The computing system includes a processor and a non-transitory computer-readable storage medium, having stored thereon program instructions that, upon execution by the processor, cause performance of operations. The operations include obtaining a first set of motion sensing data associated with a first portable people meter (“PPM”) associated with a first panelist of a household. The first set of motion sensing data includes a first number of steps over a period of time. The operations further includes obtaining a second set of motion sensing data associated with a second PPM associated with a second panelist of the household. The second set of motion sensing data includes a second number of steps over the period of time. The operations further include comparing the first number of steps and the second number of steps over the period of time; determining that the first number of steps of the first PPM and the second number of steps of the second PPM vary less than a tolerance threshold; and based on the first number of steps of the first PPM and the second number of steps of the second PPM varying less than the tolerance threshold, determining that duplicate wear of the first PPM and the second PPM occurred.

In one or more aspects, the first PPM is an application on a mobile device. The second PPM can be a wearable meter. The operations can further include determining that at least one of the first panelist or the second panelist of the household is non-compliant with a panel of an audience measurement entity. The operations can further include outputting a report based on the at least one of the first panelist or the second panelist of the household being non-compliant. The period of time can be multiple hours. The first panelist and the second panelist can be panelists on a panel for an audience measurement entity, the panel designed to measure media consumption of the first panelist and the second panelist, respectively, and to associate demographics of the first panelist and the second panelist with the media consumption. The first set of motion sensing data can include accelerometer data from the first PPM. The accelerometer data can be used to determine the first number of steps.

### BRIEF DESCRIPTION OF THE DRAWINGS

FIG. 1 is a simplified block diagram of an example audience measurement computing system in which various described operations can be implemented in accordance with one or more aspects.

FIG. 2 is another simplified block diagram of the example audience measurement computing system in which various described operations can be implemented in accordance with one or more aspects.

FIG. 3 is a simplified block diagram of an example computing device in accordance with one or more aspects.

FIG. 4 is a simplified block diagram of a portable people meter in accordance with one or more aspects.

FIG. 5 is a simplified block diagram of a duplicate wear compliance system in accordance with one or more aspects.

FIG. 6 is a flow chart of an example method in accordance with one or more aspects.

FIG. 7 is another flow chart of another example method in accordance with one or more aspects.

FIG. 8 is yet another flow chart of another example method in accordance with one or more aspects.

### DETAILED DESCRIPTION

### I. Overview

AMEs desire to know how, when, why, and where users across every demographic consume media. To measure audience exposure to media (e.g., audio and/or video), the AME collects media exposure data. The collected data can characterize who is consuming media (e.g., how many people, and which demographics) and what type of media is being consumed (e.g., movies, television program episodes, advertisements, video games, and/or Internet video clips). The collected data can include data that identifies the media (e.g., metadata, codes, signatures, and/or watermarks), data that identifies the audience members (e.g., anonymized demographic information, usernames, and/or email addresses) and, in some cases, data that identifies the means by which the media was presented to the audience members (e.g., an identifier of a streaming application and/or a time/duration of use of the streaming application). The AME can also provide this collected data to other entities, such as advertisers to improve the effectiveness of their advertising campaigns, streaming service providers (e.g., Netflix® or Hulu®) to gain a deeper insight into streaming activity, or broadcasters to gain a deeper insight into channel viewership.

To help learn how users interact with their media devices and to monitor media presentations made to users on those devices, AMEs can provide metering devices (hereinafter, “meters”) to specific users who are selected as a sample to statistically represent the population of a specific geographic area (e.g., a country, state, county, or other area), time zone, and/or demographic (e.g., age, ethnicity, and income level). Such users can be referred to as “panelists,” and collectively, the panelists are typically selected to be representative of the entire audience universe. The meters provided to the panelists can take various forms and are configured to monitor the media that the panelists view using various media devices both in and outside of monitored environments, such as a household that includes one or more panelists. For example, one such meter is a portable people meter (“PPM”), which can also be referred to herein as a “wearable”, since, in some aspects, the PPM can be worn by the panelist. The PPM can be associated with a specific person (e.g., PPM 202 is registered to Panelist A of household B). The PPM can be an electronic device that is typically worn or carried by the panelist (such as worn as a watch, worn as a necklace, clipped to a belt, placed in a pocket, and the like). The PPM can also be an electronic device such as a smartphone or smartwatch that includes a software application that is configured to perform the functions of the meter. The monitoring data that a particular meter generates is referred to herein as “panel data,” which can include data indicative of the media impressions associated with the panelists of the household with which that meter is associated, and can also include demographic data and/or other identifying information for each such panelist.

Unlike meters associated with a particular device (such as a meter in communication with a living room TV), PPMs are associated with a person rather than a device, and are miniaturized relative to the meters associated with the particular device. There is a risk of panel inaccuracy if the wrong panelist wears the PPM associated with another panelist. For example, a busy parent inadvertently or mistakenly grabs a PPM of another member of the household of panelists, while also wearing their PPM. These instances of duplicative wear are not compliant with panelist participation in the panel, e.g., when two or more meters can be carried by the same person, as this duplicate wear compromises the accuracy of the panel measurement and the integrity of the data.

Various examples are described herein for advantageously improving data integrity of the panel by determining if duplicate wear (e.g., when a Panelist is wearing their PPM and another household member's PPM) is occurring. To identify such non-compliant panelists, based on duplicate wear, accelerometers, which can be built-in with the PPMs or wearables can be used as detailed herein. When non-compliant panelist(s) are identified using the accelerometer data, their media exposure data can be excluded in the crediting process, as to not compromise the integrity of the panel by crediting media exposure to someone who had not consumed the media. When non-compliant panelist(s) are identified, the AME can require the non-compliant panelists to re-train so that the duplicate wear does not occur again. Additionally and/or alternatively, the AME can remove the panelist and/or the household from the panel for their non-compliance.

Several examples are described herein for advantageously improving a determination of duplicate wear using accelerometer data with PPMs of different types and/or locations on the body. For example, one instance of duplicate wear could be a PPM belonging to panelist A is in the pocket of panelist A, and the PPM belonging to panelist B is on the wrist of Panelist A. Further, in some instances, the PPM belonging to panelist A is an application on a smartphone, while the PPM belonging to panelist B is an electronic device on a wristband. The examples described herein provide an advantage by using accelerometer data that is invariable to the location on the panelist body and/or the type of PPM.

The operations and systems, described herein, provide techniques for improving audience measurement technology by increasing the accuracy of panel data through the use of finer accelerometer data. As described, this data can be used when extracted more frequently from sampled accelerometer measurements; for example, sampling acceleration vector components at a sampling rate of 15-20 Hz or more. Using such samples, different motion metrics can be computed to detect and identify walking, running, steps, and their count, or other types of motion like sitting. For example, in most cases, walking and running can be detected as peaks on the pre-processed acceleration signal curve. Accordingly, accelerometer data from PPMs can be used to detect steps or physical actions by a panelist.

The operations and systems, described herein, provide techniques for improving audience measurement technology by identifying duplicate wear by a panelist through the use of a number of steps. For example, if Panelist A and Panelist B have the same or similar number of step counts over an extended period of time (e.g., eight hours, one day, three days), then a computing system of the AME can flag a potential duplicate wear instance. Additionally or alternatively, a high step count metric could be used. For example, if Panelist A and Panelist B both register a high step count for the same subset of the extended period of time, then the computing system of the AME can flag a potential duplicate wear instance. The AME can then decide to remove the panelist data from crediting, retrain the panelist, and/or remove the panelist (or household) from the panel due to non-compliance.

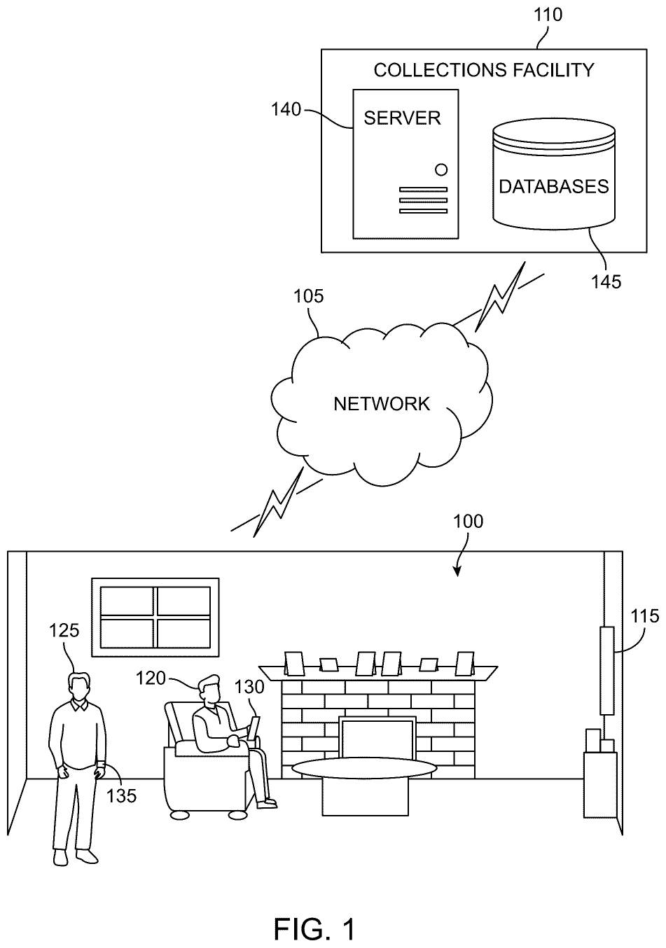

FIG. 1 is an illustration of an example media exposure environment 100 in communication via network 105 with an example collections facility 110 in accordance with one or more aspects. The media exposure environment 100 includes a media device 115 configured to display media content. The media exposure environment 100 includes a first panelist 120 and a second panelist 125. The first panelist 120 is holding a portable people meter (“PPM”) 130, which is associated with and/or registered to the first panelist 120. The second panelist 125 is wearing a portable people meter (“PPM”) 135, which is associated with and/or registered to the second panelist 125. The PPM 130 of the first panelist 120 is configured to monitor media consumption of the first panelist 120, and the PPM 135 of the second panelist 125 is configured to monitor media consumption of the second panelist 125. The collections facility 110 includes a server 140 and databases 145. The server 140 is in communication with the databases 145 for crediting media exposure and/or for determining duplicate wear of the PPMs. The collections facility 110 can be remote from the media exposure environment 100, but is not limited to being remote and is associated with the AME.

In the illustrated example of FIG. 1, the media exposure environment 100 is a room of a household (e.g., a room in a home of a panelist of an AME) that has been statistically selected to develop media ratings data for population(s)/demographic(s) of interest. In the illustrated example, one or more persons (such as the first panelist 120 and the second panelist 125) of the household have registered with the AME (e.g., by agreeing to be a panelist) and have provided demographic information to the AME to enable associating demographics with viewing activities (e.g., media exposure) for crediting media.

In one or more aspects, the media exposure environment 100 is a different room in the household than that illustrated by FIG. 1 such as a kitchen or a bedroom. In some aspects, the media exposure environment 100 is a vehicle such as a car or airplane. In some aspects, the media exposure environment 100 can be in a room of a non-statistically selected home, a theater, a tavern, a retail location, an arena, or the like.

In some aspects, the network 105 can be a wired or wireless network. For example, the network 105 can be Bluetooth® network, the Internet, a cellular telephone network, an Ethernet network, any type of service provider network, any other type of wide area network, and/or any type of local area network.

In one or more aspects, the collections facility 110 is in communication with the media exposure environment 100 via the network 105. The collections facility 110 can include one or more servers (e.g., server 140, described herein) remote from the media exposure environment 100 that processes data from meters such as the PPM 130 of the first panelist 120 and the PPM 135 of the second panelist 125. The PPM 130 of the first panelist 120 and the PPM 135 of the second panelist 125 can each communicate metering information (e.g., watermarks and signatures) about media consumption activity (e.g., viewing and/or listening activities) in the media exposure environment 100 to the collections facility 110.

In several aspects, the media device 115 is a television. In other aspects, the media device 115 is a device other than a television such as another information presentation device. An information presentation device can include a smart television, radio, a video game console, a tablet, a laptop, a cellular device, a smartphone, a computer, a mobile device, and the like. In some aspects, the media device 115 includes a television and loudspeakers operably associated with the television. The media device 115 can be a device associated with the first panelist 120 and known by the AME to be associated with the first panelist 120. For example, the PPM 130 of the first panelist 120 can be an application on a smartphone of the first panelist 120. The smartphone can be used to present media to the first panelist 120. Therefore, the smartphone can include the PPM 130 and also be the media device 115. In other aspects, the media device 115 is not known to be associated with a particular panelist by the AME and requires mapping of the media device 115 to the first panelist 120 or the second panelist 125 using the collected metering information.

In some aspects, the first panelist 120 is one panelist of a plurality of panelists in a household. The first panelist 120 can be one panelist in a household of multiple panelists (e.g., a set of parents and two teenage-aged children). In yet other aspects, additional persons (not shown), some of whom can be panelists, are located within the media exposure environment 100.

In one or more instances, the second panelist 125 is another panelist of the plurality of panelists in the household. The household can include the first panelist 120 and the second panelist 125. The household, in other instances, can include additional panelists (not shown).

In various aspects, the PPM 130 of the first panelist 120 is one or more applications installed on a smartphone that perform the function of a “software meter”. For example, the PPM 130 can include a first application for collecting metering information (e.g., the software meter) and a second application for collecting motion sensing data, such as accelerometer data and/or step counts. The PPM 130 can obtain motion sensing data from the second application on the smartphone such as a third-party fitness and/or step counter application such as, but not limited to: FitBit®, Strava®, Google Fit®, or a motion sensing application associated with the AME. The first application can be in communication with the second application. The second application that generates motion sensing data can provide the motion sensing data to the first application (e.g., the software meter) installed on the smartphone. Additionally, or alternatively, the motion sensing data and/or the metering information can be communicated or provided to the collections facility 110 of the AME that processes the data (e.g., at the server 140). In some instances, the PPM 130 communicates with (e.g., via WiFi or Bluetooth® connection) to receive motion sensing data such as accelerometer data or step count data, as described herein. In other instances, the PPM 130 is a single application provided by the AME and installed on a smartphone that collects metering information and motion sensing data of the first panelist 120.

In one or more instances, the PPM 135 of the second panelist 125 is a wearable, such as shown in FIG. 1. The PPM 135 can be an electronic device that is configured to collect metering information of the second panelist 125. The PPM 135 can be registered and/or otherwise associated with the second panelist 125 by the AME. The PPM 135 can be a wearable such as an electronic device worn on the wrist of the second panelist 125 or be a software meter (as described above) in the form of a smartwatch.

In some aspects, the PPM 130 of the first panelist 120 is the same type of PPM as the PPM 135 of the second panelist 125 such as but not limited to: an electronic portable meter device that is configured to be worn by a panelist (e.g., a wearable), one or more applications installed on a smartphone or smartwatch (e.g., a software meter), an electronic device containing one or more applications for metering and step detection, and the like. In other aspects, the PPM 130 of the first panelist differs from the PPM 135 of the second panelist 125, for example, as shown in FIG. 1. In yet other aspects, the PPM 130 and/or the PPM 135 differ in type shown in FIG. 1.

In one or more aspects, the PPM 130 of the first panelist 120 and/or the PPM 135 of the second panelist 125 is located in a different position on the panelist's body than shown in FIG. 1. For example, the PPM 130 of the first panelist 120 can be located in a pocket of the pants of the first panelist 120. In another example, the PPM 135 of the second panelist 125 can be placed around the neck of the second panelist 125, clipped to the belt of the second panelist 125, placed in a pocket on the person of the second panelist 125, worn as headphones, and the like.

In at least one aspect, the PPM 130 and the PPM 135 are in the media exposure environment 100 and are an audience measurement device provided to the first panelist 120 and the second panelist 125, respectively, and are each configured for collecting and/or analyzing the data from audio and/or video signals (for example, audio signals from the media device 115) to be sent to the collections facility 110 for analysis and crediting. For example, the PPM 130 and the PPM 135 can detect watermarks in the audio signals from the media device 115 and/or generate signatures from the audio signals from the media device 115. The PPM 130 and the PPM 135 meter can be one or more applications or a website (“a software meter”) on a media device such as a smartphone for collecting and/or analyzing media viewed by the first panelist 120 and/or the second panelist 125, respectively.

In one or more aspects, the media exposure environment 100 also includes a streaming meter (not shown) that is configured to collect metering information about streaming activity in the media exposure environment 100 of the first panelist 120 and the second panelist 125. In some instances, the streaming meter can be coupled to a router via a wired connection or a wireless connection. Alternatively, the streaming meter is indirectly coupled to the router. The streaming meter can be a network device like a router that has been reprogrammed to perform streaming meter operations, a purpose-built computing device, the router and the streaming meter can be a singular device, or the like. In other instances, the streaming meter is omitted. The streaming meter can include a software meter to communicate with one or more application programming interface(s) of a media presentation device such as the media device 115.

In one or more aspects, the media exposure environment 100 also includes a panel meter (not shown). The panel meter is a meter that communicates metering information about media consumption in the media exposure environment 100 to the collections facility 110. The panel meter is not a wearable meter, designed to be carried by the panelist throughout the day, instead the panel meter is associated with a media presentation device such as the media device 115. The panel meter is configured to collect and/or analyze data from audio and/or video signals (for example, audio and/or video signals from the media device 115) to be sent to the collections facility 110 for analysis and crediting. The panel meter is coupled to and/or operably associated with the media device 115. For example, the panel meter is coupled directly to the media device 115. In other examples, a universal serial bus (USB) dongle is coupled to the media device 115, and the USB dongle wirelessly couples the media device 115 to the panel meter.

In some aspects, the server 140 can be a single server or a plurality of servers. The plurality of servers can be located in a plurality of locations remote from the media exposure environment 100. The server 140 can be a central processor system that is in communication with the databases 145. The server 140 can have a rules-based engine to determine which database of the databases 145 to access.

In various aspects, the databases 145 can be a singular database or a plurality of databases. The databases 145 can store information sent from the PPM 130 and/or the PPM 135. For example, the databases 145 can store collected metering information sent from the PPM 130 and/or the PPM 135 including, but not limited to: signatures, watermarks, metadata, timestamps, PPM identification information, and other media identifying information. The databases 145 can also store motion sensing data sent from the PPM 130 and/or the PPM 135 such as accelerometer data, an accelerometer signal, high step count events, a number of steps, and the like. The databases 145 can also store demographic information about the panelists such as the first panelist 120 and media content information (such as signatures and watermark information) to identify media content. The data in the databases 145 can be used to determine what media content was presented, who watched the media content, what the demographics of the person who watched the media content, and then credit the media content as being presented to a particular demographic. The data in the databases 145 can also be used to determine if the panelists such as the second panelist 125 is complying with the rules of the panel, for example, no duplicate wearing of PPMs.

In operation, in one or more aspects, the first panelist 120 and the second panelist 125 are consuming media via the media device 115 in the media exposure environment 100. The first panelist 120 is holding their PPM 130, and the second panelist 125 is wearing their PPM 135. As the media is being presented on the media device 115, the PPM 130 and the PPM 135 receives audio and/or video content information provided by the media device 115. The audio/video content may be encoded to facilitate subsequent identification of the audio/video content and/or the PPM 130 and/or the PPM 135 may be configured to use signature generation techniques to identify audio/video content received by the respective PPMs. The PPM 130 of the first panelist 120 may receive different audio/video content than the PPM 135 of the second panelist 125 based on the panelist's unique location (e.g., within their household, at another location outside their household, etc.) and their location relative to the media device 115 to which the first and second panelists 120, 125 and their PPM 130, 135, respectively, are exposed. The PPM 130 and/or the PPM 135 also collects motion sensing data (such as the number of step counts) the first panelist 120 and the second panelist 125, respectively, take over a given period of time (such as a day). The PPM 130 and/or the PPM 135 transmits via the network 105 to the collections facility 110: (1) the audio and/or video content information provided by the media device 115, (2) location data, and/or (3) motion sensing data. The audio and/or video content information, location data, and motion sensing data can each be stored in the databases 145. Another database can contain demographic and profile information of the first panelist 120 and the second panelist 125. The collections facility can determine using the motion sensing data and/or the location data that the first panelist 120 was in possession of their respective PPM 130 and that the second panelist 125 was in possession of their respective PPM 135 and credit the consumption of media from the media device 115 in accordance with the demographics of the first panelist 120 and the second panelist 125, respectively, using the server 140.

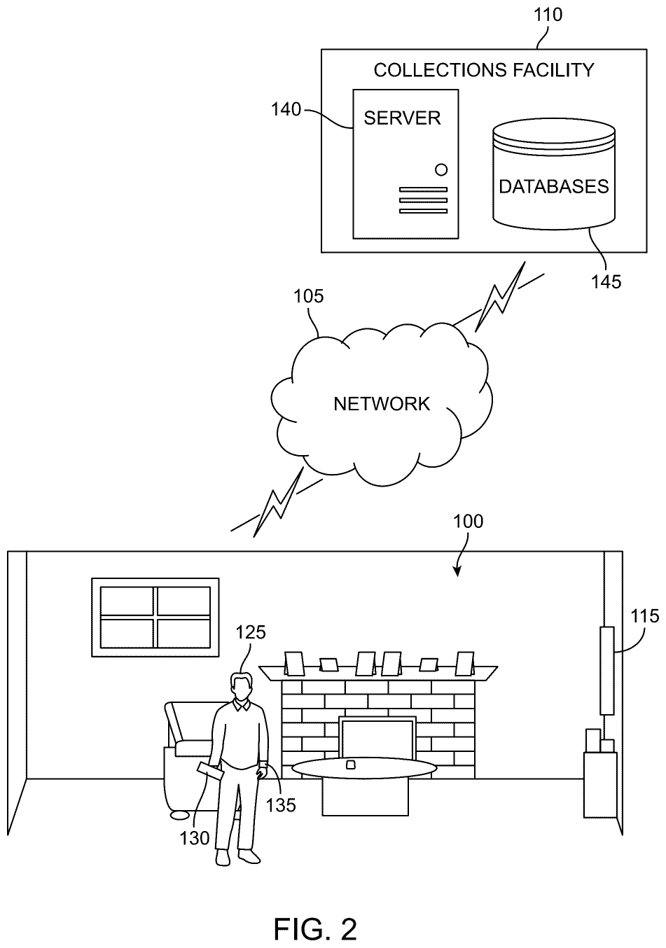

With reference to FIG. 2, with continuing reference to FIG. 1, another illustration of the example media exposure environment 100 in accordance with one or more aspects is described and includes several components described in FIG. 1. Components in FIG. 2 in common with FIG. 1 are given the same reference numerals. The media exposure environment 100 includes the media device 115 configured to display media content. The media exposure environment 100 includes the second panelist 125. The first panelist 120 is no longer in the media exposure environment 100. The second panelist 125 is holding the PPM 130, which is associated with and/or registered to the first panelist 120. The second panelist 125 is also wearing the PPM 135, which is associated with and/or registered to the second panelist 125. The PPM 130 of the first panelist 120 is configured to monitor and collect metering information related to media consumption of the first panelist 120, and the PPM 135 of the second panelist 125 is configured to monitor and collect metering information related to media consumption of the second panelist 125. The metering information collected by the PPM 130 and the PPM 135 is transmitted to the collections facility 110 using the network 105. The collections facility 110 includes the server 140 and the databases 145. The server 140 is in communication with the databases 145 for crediting media exposure and/or for determining duplicate wear of the PPMs by the second panelist 125. The collections facility 110 is remote from the media exposure environment 100 and is associated with the AME.

In operation, the second panelist 125 is wearing the PPM 135 associated with the second panelist 125 by the AME and holding the PPM 130 associated with the first panelist 120 (not shown and not currently in the media exposure environment 100), while the second panelist 125 is in the media exposure environment 100. The second panelist 125 wearing the PPM 135 and holding the PPM 130 is considered duplicate wear and is non-compliant with the rules of the panel of the AME. The second panelist 125 can be duplicate wearing (and/or holding) the PPM 130 and the PPM 135 throughout the day. The second panelist 125 enters the media exposure environment 100 to watch a presentation of media on the media device 115. The PPM 130 and PPM 135 log motion sensing data (such as accelerometer data and/or step counts) of the second panelist throughout the day including when he/she is in the media exposure environment 100 and transmit the motion sensing data to the collections facility 110 using the network 105. The PPM 130 and the PPM 135 receives audio and/or video content information provided by the media device 115. The audio/video content may be encoded to facilitate subsequent identification of the audio/video content and/or the PPM 130 and/or the PPM 135 may be configured to use signature generation techniques to identify audio/video content received by the PPMs. The PPM 130 and the PPM 135 transmit the metering information (e.g., the audio and/or video content information) to the collections facility 110. The PPM 130 and the PPM 135 can also transmit, in some aspects, location data to the collections facility. The databases 145 can store demographic information of the panelist (such as the second panelist 125), the location data of the PPMs, the metering information, and/or the motion sensing data. Without the motion sensing data, the collections facility would attribute the demographics of the first panelist 120 as having watched the media content of the media device 115, since the PPM 130 of the first panelist 120 logged metering information and would attribute the demographics of the second panelist 125 as having watching the media content of the media device 115, since the PPM 135 of the second panelist 125 logged metering information. However, the collections facility, using the server 140, can determine that the second panelist 125 is wearing and/or holding both the PPM 130 and the PPM 135 using the motion sensing data (as described herein). The collections facility 110 can then decide to credit only the second panelist as having watched the media presentation on the media device 115, retrain the panelists of the household (such as the second panelist 125 and the first panelist 120) on proper wearing of the PPMs, or remove the first panelist 120 and/or the second panelist 125 from the panel due to non-compliance, ensuring data integrity and accuracy of the panel of the AME.

### II. System Architecture

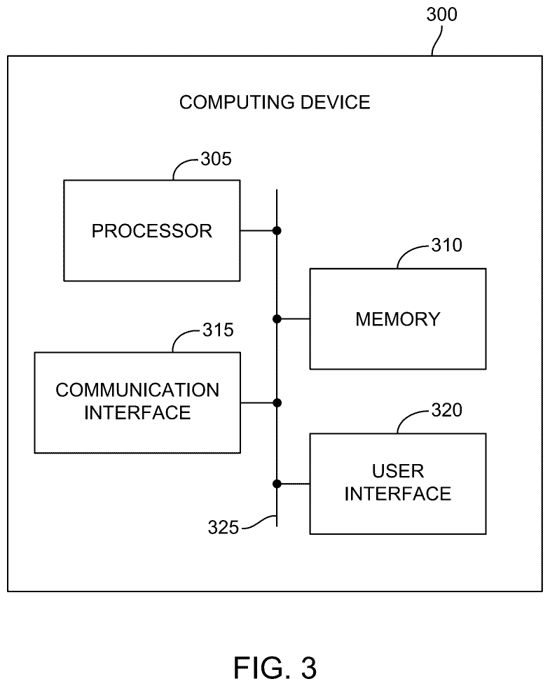

FIG. 3 is a simplified block diagram of an example computing device 300. The computing device 300 can be configured to perform one or more operations, such as the operations described in this disclosure. As shown, the computing device 300 can include various components, such as a processor 305, memory 310, a communication interface 315, and/or a user interface 320. These components can be connected to each other (or to another device, system, or other entity) via a connection mechanism 325.

The processor 305 can include one or more general-purpose processors and/or one or more special-purpose processors.

Memory 310 can include one or more volatile, non-volatile, removable, and/or non-removable storage components, such as magnetic, optical, or flash storage, and/or can be integrated in whole or in part with the processor 305. Further, memory 310 can take the form of a non-transitory computer-readable storage medium, having stored thereon computer-readable program instructions (e.g., compiled or non-compiled program logic and/or machine code) that, upon execution by the processor 305, cause the computing device 300 to perform one or more operations, such as those described in this disclosure. The program instructions can define and/or be part of a discrete software application. In some examples, the computing device 300 can execute the program instructions in response to receiving an input (e.g., via the communication interface 315 and/or the user interface 320). Memory 310 can also store other types of data, such as those types described in this disclosure. In some examples, memory 310 can be implemented using a single physical device, while in other examples, memory 310 can be implemented using two or more physical devices.

The communication interface 315 can include one or more wired interfaces (e.g., an Ethernet interface) or one or more wireless interfaces (e.g., a cellular interface, Wi-Fi interface, or Bluetooth® interface). Such interfaces allow the computing device 300 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission. In some instances, the network 102 is the communication interface 315.

The user interface 320 can facilitate interaction between computing device 300 and a user of computing device 300, if applicable. As such, the user interface 320 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 320 can include hardware and/or software components that facilitate interaction between the computing device 300 and the user of the computing device 300.

The connection mechanism 325 can be a cable, system bus, computer network connection, or other form of a wired or wireless connection between components of the computing device 300.

One or more of the components of the computing device 300 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 300 can be combined into a single component, and the function described herein for a single component can be subdivided among multiple components.

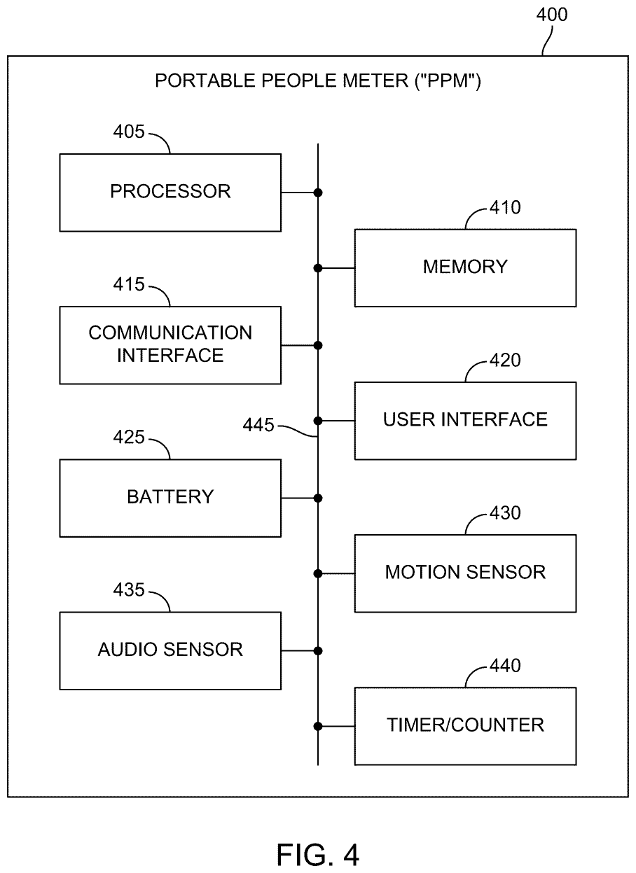

FIG. 4 is a simplified block diagram of an example portable people meter (“PPM”) 400. The PPM 400 can be configured to perform one or more operations, such as the operations described in this disclosure. As shown, the PPM 400 can include various components, such as a processor 405, memory 410, a communication interface 415, a user interface 420, a battery 425, a motion sensor 430, an audio sensor 435, and/or a timer/counter 440. One or more of these components can be connected to each other (or to another device, system, or other entity) via a connection mechanism 445.

In some instances, the PPM 400 can be the PPM 130 and/or the PPM 135 shown in FIGS. 1 and 2. The PPM 400 can be an electronic device that is assigned or registered to a particular person (i.e., panelist) by an AME to monitor the media consumption of that particular person. The PPM 400 can be portable and easily carried and/or worn by the person. The PPM 400 can be a wearable, such that the PPM 400 can be worn on the body or apparel of the panelist (such as clipped to a belt, inserted into a bracelet or watch band, worn as a necklace, and the like). The PPM 400 can also be carried by the panelist such as carried in the hand of the panelist, placed in a pocket of the panelist's apparel, in the purse of the panelist, and the like. The PPM 400 can be designed to be worn or carried by the panelist throughout their day, as the panelist goes about their daily routine to monitor the panelist's media consumption. The PPM 400 can be configured to use a variety of techniques to monitor the media consumption of the panelist (e.g., viewing and/or listening activities) of a person.

In one or more instances, the PPM 400 is a software meter. The PPM 400 can be included in at least a portion of a smartphone, smart watch, or other portable electronic device capable of installing one or more applications forming the software meter. For example, the PPM 400 can include the one or more applications installed on the smartphone that use one or more components of the smartphone to capture media consumption data and/or motion sensing data (e.g., microphone of the smartphone can capture audio and/or a smartphone's motion sensor can capture step counts). The one or more applications installed on the smartphone or smart device of the panelist act as a wearable PPM and is easily carried by the panelist throughout their daily routine to monitor the media consumption of the panelist.

In some instances, the processor 405 is the same as the processor 305 shown in FIG. 3.

In various aspects, the processor 405 is in communication with and/or operably coupled to the memory 410, the communication interface 415, the user interface 420, the battery 425, the motion sensor 430, the audio sensor 435, and/or the timer/counter 440. The processor 405 can include one or more processors in communication and/or operably coupled to one or more of the components shown in FIG. 4. The processor 405 can be in communication with and/or operably coupled to the one or more components using the connection mechanism 445.

In one or more aspects, the memory 410 is the same as the memory 310 depicted in FIG. 3.

In several instances, the memory 410 is in communication with and/or operably coupled to the processor 405, the communication interface 415, the user interface 420, the battery 425, the motion sensor 430, the audio sensor 435, and/or the timer/counter 440. The memory 410 can include one or more memories in communication and/or operably coupled to one or more of the components shown in FIG. 4. The memory 410 can include storage of software components such as, but not limited to, an operating system (e.g., LINUX®, WINDOWS®, ANDROID®, macOS®, Wear OS, WATCHOS®, GarminOS, and the like), a global positioning system (GPS) module, one or more applications (such as the software meter described herein or a media player), an audio decoder, and the like. The memory 410 can be in communication with and/or operably coupled to the one or more components using the connection mechanism 445.

In various instances, the communications interface 415 is the same as the communication interface 315 depicted in FIG. 3. The communications interface 415 can be configured to communicate with a server of the AME (such as the server 140) to store data from the PPM 400 into a database (such as a database of the databases 145). The communications interface 415 can use the network 105 to communicate with the server of the AME. The communications interface 415 can be configured to transmit (1) media consumption data, (2) location data, and/or (3) motion sensing data, as described herein to the AME for crediting and/or for determining compliance (e.g., no duplicate wear).

In one or more instances, the user interface 420 is the same as the user interface 320 shown in FIG. 3. The user interface 420 can be a display screen of the PPM 400 such as a display screen on a smartphone or a display screen on a smartwatch. Additionally and/or alternatively, the user interface 420 can be the user interface of the one or more applications of the software meter, described herein. The user interface of the one or more applications of the software meter can be configured to allow the panelist to interact with the software meter (e.g., read a message sent from the AME regarding compliance). The user interface 420 can, in some instances, be one or more buttons on an electronic device that allows the panelist to perform inputs (such as turning the PPM 400 ON or OFF). The user interface 420 can, in one or more aspects, be a series of lights on an electronic device that inform the panelist of an action (e.g., charge the battery, the PPM 400 is transmitting data, and the like).

In one or more instances, the battery 425 is a battery or power source that powers one or more components of the PPM 400. The battery 425 can be a rechargeable battery. The battery 425 can be, for example, a rechargeable lithium-ion battery or a lithium polymer battery.

In some aspects, the motion sensor 430 is a motion detection device such as but not limited to one or more of: an accelerometer, a three-axis accelerometer, an accelerometer integrated circuit, a gyroscope, a piezo-gyroscope integrated circuit, or a digital compass. The motion sensor 430 can be configured to detect small body movements of the panelist, generate motion data related to the small body movements, and communicate the motion data to the processor 405 and/or the communication interface 415. The motion sensor 430 can be configured to sample accelerometer measurements. For example, the motion sensor 430 can sample acceleration vector components at a sampling rate between 15-20 Hz or more. The motion sensor 430 can include, be combined with, and/or validated with location services information (such as GPS coordinates and cellular service information). For example, the GPS module of the PPM 400 or a GPS module on another device or application associated with the panelist can provide GPS location information that can determine the distance traveled by the panelist which can be used in combination with the motion sensing data. The motion sensor 430 can include one or more modules, algorithms, and/or programs to convert the sampled accelerometer measurements, motion signals, and/or the pre-processed acceleration curve into a number of steps and/or counts.

In some instances, the motion sensor 430 is a separate component from the PPM 400. For example, the panelist could wear a fitness tracking device (e.g., FitBit®) and/or have an application on their smartphone, smartwatch, and/or electronic fitness device that measures motion sensing data (such as accelerometer data and/or step count data), which can transmit the motion sensing data to the PPM 400 (such as an application associated with the PPM 400) and/or a server of the AME (such as the server 140). The PPM 400 can obtain motion sensing data from the motion sensor 430. For example, the application installed on a smartphone (e.g., PPM 400) can communicate with the fitness application installed on the smartphone, smartwatch, or electronic fitness device to receive motion sensing data from the motion sensor 430. The motion sensing data transmitted to the PPM 400 and/or the server of the AME can also include a timestamp to compare the media consumption data from the PPM 400 with the motion sensing data for crediting and compliance determinations by the AME. The motion sensor 430 can be configured to sample acceleration vector components at a sampling rate of 15-20 Hz. The motion sensor 430 can also be configured to detect, using these samples, whether a panelist is walking, running, a number of steps, and other types of motion including sitting. For example, the motion sensor (such as the motion sensor 430) can be configured to create an acceleration signal curve. The acceleration signal curve can be used to identify when a panelist is walking or running by detecting the peaks on the pre-processed acceleration signal curve.

In various instances, the audio sensor 435 includes at least one of: a microphone, an array of microphones, or any other suitable transducer for converting audio information into electrical information. If the PPM 400 forms at least a portion of a smartphone or smartwatch, the audio sensor 435 can be the microphone(s) integrated into the smartphone or smartwatch. The audio sensor 435 is configured to detect via the microphone(s) the media being presented in a media presentation environment around the PPM 400 and the associated panelist. In some instances, the audio sensor 435 also includes one or more speakers (which also can be integrated into the smartphone or smartwatch) if the PPM 400 is an application on the smartphone or smartwatch. The audio sensor 435 can be configured to detect, via the speakers, media being consumed or presented on the smartphone or smartwatch. In some instances, the audio sensor 435 along with applications stored in the memory 410 via implementation by the processor 405 is able to detect watermarks embedded in media being presented to the panelist near the PPM 400. The embedded watermarks can be used to identify the media being presented to the panelist. The audio sensor 435 can capture audio signals from a media presentation device (such as the media device 115 or a smartphone) displaying and/or presenting media content (such as movies, television shows, video games, music and the like). The audio signals can be captured by the audio sensor 435 and signatures can be generated from the audio signals of the media presentation device. The signatures can be compared to one or more reference signatures stored in a reference database to identify the media content that was presented to the panelist wearing and/or holding the PPM 400. Additionally or alternatively, the audio sensor 435 can collect metadata associated with the media content presented and/or consumed by the panelist associated with the PPM 400. The metadata can be sent to a server of the AME (e.g., the server 140) to identify the media content being presented and/or consumed by the panelist associated with the PPM 400.

In one or more aspects, the timer/counter 440 is configured to generate a timed event or count that causes an action to occur when a threshold is satisfied. For example, in order to transmit the media consumption and/or motion sensing data to a server of the AME (such as the server 140), a timed event (e.g., twelve hours or a day) can be required, and the timer/counter 440 can be reset once a successful transmission to the server occurs. If a successful transmission to the server does not occur, the timer/counter can reset with a lower threshold value (e.g., 1 hour or 2 hours) to retry transmitting the data to the server.

In some aspects, the connection mechanism 445 is the same as the connection mechanism depicted in FIG. 3.

In operation, the PPM 400 is worn and/or carried by a panelist (such as the second panelist 125) throughout the day. The panelist wakes up and checks the user interface 420 of the PPM 400 to make sure that the device is ON and that the battery 425 is charged. The panelist wears and/or carries the PPM 400 throughout her day. The processor 405 executes instructions and provides the processing power for the PPM 400 and its components to collect measurement data of the panelist. The panelist during the day turns on the television to watch her favorite show. The audio sensor 435 detects media identifying information from the show (such as watermarks). The watermarks can then be stored in the memory 410. As the panelist walks with the PPM 400, the motion sensor 430 collects motion data such as the number of steps taken by the panelist throughout the day. The motion data can be stored in the memory 410. The timer/counter 440 determines a threshold amount of time has passed since the last transmission to a server of the AME. When the threshold is met, the communications interface 415 sends the watermarks and the motion data stored in the memory 410 to the server of the AME.

In one or more instances, additional information is sent from the PPM 400 to the server of the AME such as audio signals, signatures, location data, timestamps, panelist identifier (e.g., panelist ID and PPM ID), other media identifying information, and the like.

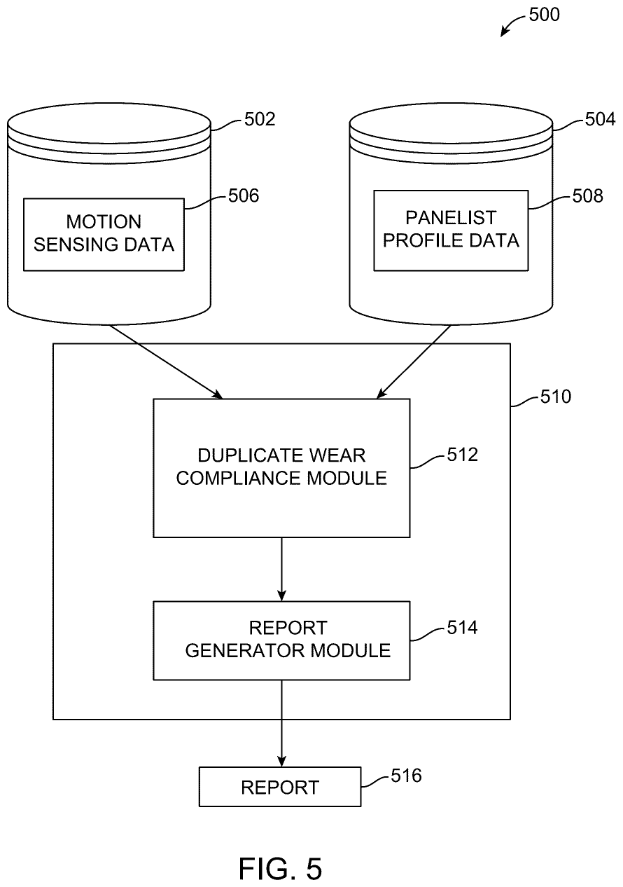

Referring now to FIG. 5, with continuing reference to FIGS. 1-4, FIG. 5 is a simplified block diagram of an example compliance system 500 for the AME to determine if a panelist is wearing more than one PPM (such as the PPM 400). The compliance system 500 includes a first database 502 and a second database 504. The first database 502 includes motion sensing data 506. The second database 504 includes panelist profile data 508. The first database 502 and the second database 504 are in communication with and/or operably coupled to a computing device 510 such that the computing device 510 can receive at least a portion of the motion sensing data 506 and/or at least a portion of the panelist profile data 508. The computing device 510 can include a duplicate wear compliance module 512. The duplicate wear compliance module 512 is configured to receive at least a portion of the motion sensing data 506 and/or at least a portion of the panelist profile data 508 from the first and second databases 502, 504, respectively. The duplicate wear compliance module 512 is in communication with and/or operably coupled to the report generator module 514. The report generator module 514 is configured to generate a report 516. The report 516 can be displayed on the computing device 510 and/or transmitted to a different computing device for display.

In some instances, the first database 502 is a database of the databases 145. The first database 502 can be associated with the collections facility 110 of the AME.

In one or more aspects, the second database 504 is a database of the databases 145. The second database 504 can be associated with the collections facility 110 of the AME. The second database 504 can be associated with a third-party. The third-party database can include information about the panelist such as demographic and geographic information (e.g., age, race, ethnicity, income, household size, market of the panelist, and the location of the panelist).

In some instances, the first database 502 can be combined with the second database 504 such that the motion sensing data 506 and the panelist profile data 508 are stored in the same database.

In various instances, the motion sensing data 506 includes a number of counts and/or steps taken by a person (such as the first panelist 120) over a period of time. For example, the period of time can be 8 hours, 24 hours, or 48 hours. The motion sensing data 506 can include whether the person is walking, running, or other types of motion (including sitting). The motion sensing data 506 can be sent from a PPM (such as the PPM 135 or the PPM 130). The motion sensing data 506 can be transmitted and/or provided by a secondary device that is separate and distinct from the PPM such as, but not limited to: a fitness watch, a smartphone, or a pedometer. The motion sensing data can also include location information. This location information can include GPS coordinates, can indicate whether the person is in the home or out of home, and the like. The motion sensing data can also include timestamps related to the motion sensing data. These timestamps can indicate when the panelist moved throughout the period of time, for example, throughout the day.

In one or more aspects, the panelists profile data 508 can include demographic information of one or more panelists of the AME. The panelists profile data 508 can include demographic information for each panelist of a household of panelists of the AME. The panelists profile data 508 can include demographic information such as: number of children, household size, income level, education level, employment status, age, race, ethnicity, and the like. The panelist profile data 508 can also include location information such as market location or geographic information about where the panelist resides (e.g., Midwest, Atlanta, or rural). The panelist profile data 508 can include a panelist identifier and an associated PPM identifier. For example, Panelist 1013 of Household 456 is associated with PPM device 2345, and Panelist 1014 of the Household 456 is associated with PPM device 2346. The panelist profile data 508 can include historic motion sensing data and baseline motion data for the panelist that is created by the AME (e.g., panelist walks at least 6,000 steps a day and a panelist runs a mile on Monday, Wednesday, and Friday). The panelist profile data 508 can include exercise information about the panelist which can be provided by the panelist or determined from the motion sensing data.

In some aspects, the computing device 510 is the computing device 300. In one or more aspects, the computing device 510 is the server 140 of the collections facility 110 of the AME. The computing device 510 can also be a plurality of servers. The computing device 510 can include one or more modules implemented by one or more processors. The computing device 510 can be configured to identify when a panelist is wearing and/or carrying multiple PPMs. The computing device 510 can be configured to remove media measurement data associated with one or more of the multiple PPMs worn and/or carried by the panelist for at least the period of time identified as duplicate wear. The computing device 510 can be configured to flag a panelist as non-compliant.

In some aspects, the duplicate wear compliance module 512 or another module of the computing device 510 includes comparing location data from a first PPM to a second PPM. The comparison can be over a period of time (e.g., 8 hours or a day) to determine if the first PPM and the second PPM have the same (or within a threshold level of similarity) location data over a portion of the period of time (e.g., 4 hours or 8 hours). A threshold distance for a threshold amount of time between the PPMs can be created to determine if no duplicate wear occurred. For example, if out of the total period of time of 8 hours, the first PPM was 3 miles from the second PPM for 6 hours of the 8 hours, then the duplicate wear compliance module 512 determines that no duplicate wear occurred. However, in another example, if the first PPM and the second PPM are showing similar location data (e.g., 10 feet apart or less) over a period of time (such as 8 hour or 12 hours) or no location data is present for either the first PPM and/or the second PPM, then the duplicate wear compliance module processes the motion sensing data to determine duplicate wear.

In various aspects, the duplicate wear compliance module 512 processes the motion sensing data 506 sent from a PPM. In other aspects, at least a portion of the processing of the motion sensing data occurs at the PPM. For example, the motion sensing data of a first PPM (such as the PPM 130) can be extracted and computed to determine a number of steps and/or step count for a PPM and aligned with the motion sensing data of a second PPM (such as the PPM 135) to detect duplicate wear. For example, the duplicate wear compliance module 512 can use different metrics to determine if there is significant similarity (e.g., a tolerance threshold for a similarity of data) to determine that at least two PPMs are being used, carried, and/or worn by the same person and/or panelist. One metric used by the duplicate wear compliance module 512 can be a comparison of the number of steps in a given period of time between at least two PPMs. The period of time could be multiple hours, such as, but not limited to: 8 hours, 12 hours, 24 hours, and 48 hours. The multiple hours can be contiguous. For example, if the tolerance threshold was used (e.g., 5%, 10%, and 15%), the number of steps from the at least two PPMs can be compared by the duplicate wear compliance module over the given period of time. If the number of steps varies more than the threshold tolerance (e.g., 5%, 10%, and 15%), then the compared PPMs are identified as not being duplicate wear and/or as in compliance. To detect the number of steps accurately for these duplicative PPMs over a long period of time, a high sampling rate can be used (e.g., around or at least 25 Hz-50 Hz). Another step count metric that can be used by the duplicate wear compliance module 512 is to compare whether a given two PPMs both have high step counts indicative of walking or running or some other physical activity (e.g., relative to sitting). For example, if two PPMs both have high step counts for a subset of the given time, then those PPMs can also be identified as duplicative because it is highly unlikely that two individuals from the same panelist household would have the same or similar physical activity regime, particularly if this comparison is made for multiple, different time periods. Accordingly, activity comparisons can be made by the duplicate wear compliance module 512 over different time windows to see if the activity varies or not for two or more compared PPMs. As another example, the distribution of steps counts by hour (e.g., a step rate) could be used to compare to a step rate tolerance threshold. For example, if a step rate tolerance threshold was used (e.g., 10%), the step rates from both PPMs can be compared over a given period of time. If the step rate varies by more than 10% between the two or more compared PPMs, then the compared PPMs are identified as not duplicate wear and/or as in compliance. In some implementations, eight hours (e.g., a day) of accelerometer or step count data can be used for the comparisons. The duplicate wear compliance module 512 can use the panelist profile data 508 to determine which PPM devices need to be compared (i.e., comparing PPM devices from a single household). Other aspects of the panelists profile data 508 can be used by the duplicate wear compliance module 512 to determine non-compliance.

In some instances, the report generator module 514 is configured to output a report to one or more computing devices (e.g., computing device 300) of the AME. The report generator module 514 or an additional module (not shown) can receive input from one or more databases of the AME (such as the databases 145) that includes the media consumption information. The report generator module 514 or the additional module can determine what media consumption occurred during the time period(s) of non-compliance for the PPM(s). The report generator module 514 can be configured to send an alert, report, and/or communication to the panelist and/or the household based on the non-compliance. The alert, report, and/or communication can include a warning, a time to re-train the panelist on proper compliance, or remove the panelist and/or household from the panel due to non-compliance.

In several instances, the report 516 can include that duplicate wear was detected and/or that a panelist and/or a household of panelists are not in compliance. This report 516 can also indicate when the duplicate wear was detected and how often the duplicate wear was detected. The report 516 can include what media and/or demographics should be removed from crediting based on which PPM(s) of the duplicate wear did not belong to the panelist. The report 516 can also flag a panelist and/or the household of the panelist as non-compliant.

In operation, the computing device 510 of the AME obtains motion sensing data 506 from the first database 502 and obtains panelist profile data 508 of the second database 504. The duplicate wear compliance module 512 of the computing device 510 determines using the panelist profile data 508 which PPMs belong to a single household for comparison. The duplicate wear compliance module 512 then associates the motion sensing data of the PPMs selected for comparison over a given period of time. The duplicate wear compliance module 512 then uses one or more motion metrics to determine if significant similarity exists between two or more PPMs of the household. For example, if the number of steps of a first PPM of the household is within a threshold of similarity (e.g., 10%) of a second PPM of the household over the given time (e.g., a day), then the duplicate wear compliance module 512 flags the day as non-compliant. The report generator module 514 can output the report 516 indicating the non-compliance due to the duplicate wear.

### III. Example Operations

The computing device 300 and/or components thereof can be configured to perform and/or can perform one or more operations. Examples of these operations and related features will now be described.

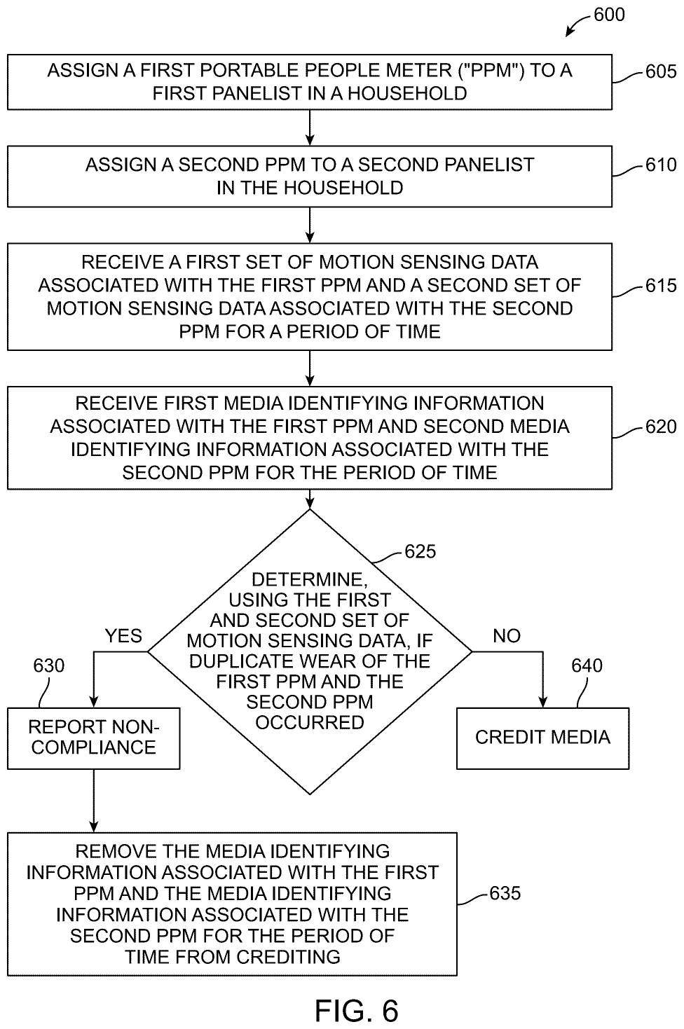

Referring to FIG. 6, with continuing reference to FIGS. 1-5, a method 600 for determining duplicate wear of a first PPM and a second PPM by a single panelist of a household is described. Method 600 is illustrated as a set of operations or blocks 605 through 640. Not all of the illustrated blocks 605 through 640 can be performed in all aspects of method 600. One or more blocks that are not expressly illustrated in FIG. 6 can be included before, after, in between, or as part of the blocks 605 through 640. In some aspects, one or more of the blocks 605 through 640 can be implemented, at least in part, by the computing device 300 and/or the server 140 in the form of executable code stored on non-transitory, tangible, machine-readable media that when run by one or more processors can cause the one or more processors to perform one or more of the processes. In one or more aspects, the blocks in method 600 are performed within a computing system and/or computing devices, as described herein.

The method 600 includes assigning a first portable people meter (“PPM) to a first panelist in a household at a block 605; assigning a second PPM to a second panelist in the household at a block 610; receiving a first set of motion sensing data associated with the first PPM and a second set of motion sensing data associated with the second PPM for a period of time at a block 615; receiving first media identifying information associated with the first PPM and second media identifying information associated with the second PPM for the period of time at a block 620; determining, using the first and second set of motion sensing data, if duplicate wear of the first PPM and the second PPM occurred at a block 625; if so, reporting noncompliance at a block 630 and removing the media identifying information associated with the first PPM and the media identifying information associated with the second PPM for the period of time from crediting at a block 635; and if not, crediting media at a block 640.

In some instances, the block 605 can include registering a first PPM to the first panelist. The association can include storing a Panelist Identifier along with a PPM identifier. For example, the Panelist Identifier could be a Panelist ID number to anonymize the panelist and the PPM identifier could be a unique manufacturing number associated with a specific PPM. The block 605 can include a field representative or another representative of the AME assigning the first PPM with the first panelist. The block 605 can include storing the association in a database such as the second database 504. The block 605 can include providing and/or sending the first PPM to the first panelist, the first PPM associated with the first panelist. The first PPM can be a wearable device provided by the AME or a third-party associated with the AME. The block 605 can include instructing the first panelist to download and install one or more application(s) onto a device such as a smartwatch or a smartphone. The one or more application(s) can be the first PPM. The device can be a device owned by the first panelist, a device owned by the household of the first panelist, or a device provided by the AME. The application can be then associated with the first panelist via an account, application identifier, device identifier, or the like. In some instances, the first panelist is assigned a plurality of PPMs, for example a wearable PPM and an application on the first panelist's mobile device.

In one or more instances, the block 610 includes registering a second PPM to the second panelist. The association can include storing a Panelist Identifier along with a PPM identifier. For example, the Panelist Identifier could be a Panelist name and the PPM identifier could be a unique number associated with a specific PPM assigned by the AME. The block 610 can include a field representative or another representative of the AME assigning the second PPM with the second panelist. For instance, the block 610 can include providing and/or sending the second PPM to the second panelist, the second PPM being associated with the second panelist. The block 610 can include storing the association in a database such as the second database 504. The second PPM can be a wearable device provided by the AME or a third-party associated with the AME. The block 605 can include instructing the second panelist to download and install one or more application(s) onto a device such as a smartwatch or a smartphone. The one or more application(s) can be the second PPM. The device can be a device owned by the second panelist, a device owned by the household of the second panelist, or a device provided by the AME. The application can be then associated with the second panelist via an account, application identifier, device identifier, and the like. In some instances, the second panelist is assigned a plurality of PPMs for example a wearable PPM and an application on the second panelist's mobile device. The block 610 can occur simultaneously to the block 605. The block 610 can occur prior to the block 605.

In some aspects, the household includes the first panelist and the second panelist. In other aspects, the household includes additional panelists. The method 600 is not limited to only comparing two PPMs but can include comparing all PPMs in a household.

In various instances, the block 615 includes receiving the first set of motion sensing data associated with the first PPM from the first PPM and the second set of motion sensing data associated with the second PPM from the second PPM. The first PPM and/or the second PPM can be one of: the PPM 130, the PPM 135, or the PPM 400. The first set of motion sensing data and the second set of motion sensing data can be the motion sensing data 506. The block 615 can include receiving the first set of motion sensing data associated with the first PPM for the period of time at a first time period, and receiving the second set of motion sensing data associated with the second PPM for the period of time at a second time period, different than the first time period. The block 615 can include receiving a transmission via a network (such as the network 105) from the first PPM and receiving a transmission via the network from the second PPM. The block 615 can include receipt of the first set of motion sensing data and receipt of the second set of motion sensing data at the collections facility 110. The block 615 can include storing the first set of motion sensing data and the second set of motion sensing data in a database (such as databases 145 or the first database 502). The first set of motion sensing data can include motion metrics derived from accelerometer data from the first PPM and the second set of motion sensing data can include motion metrics derived from accelerometer data from the second PPM. The first set of motion sensing data and/or the second set of motion sensing data can include motion metrics for a given period of time (e.g., 12 hours). The first set of motion sensing data and/or the second set of motion sensing data can include whether a person was undergoing increased physical activity (e.g., running) or sitting. The first set of motion sensing data and/or the second set of motion sensing data can include step detections and/or step counts. The first set of motion sensing data and/or the second set of motion sensing data can include location information (e.g., GPS coordinates and in-home versus out-of-home status). The first set of motion sensing data and/or the second set of motion sensing data can also include timestamps associated with movement (or the lack thereof) of the first panelist and the second panelist. The first set of motion sensing data and/or the second set of motion sensing data can also categorize periods of time as high step count (e.g., running) versus periods of times with low step count (e.g., sitting or laying down). The block 615 can include receiving the first set of motion sensing data associated with the first PPM and/or receiving the second set of motion sensing data associated with the second PPM from a database (such as the databases 145 or the first database 502). The block 615 can include receiving the first set of motion sensing data and/or the second set of motion sensing data at the computing device 510 and/or the duplicate wear compliance module 512 from the first database 502.

In some aspects, the block 620 includes receiving the first media identifying information associated with the first PPM and the second media identifying information associated with the second PPM for the period of time. The period of time can be, but not limited to: 8 hours, 12 hours, 24 hours, and 48 hours. The type of media identifying information of the first PPM can be different from the type of media identifying information of the second PPM. For example, the first media identifying information associated with the first PPM could be related to watermarks, whereas the second media identifying information associated with the second PPM could be related to signatures. The underlying media content of first media identifying information of the first PPM and the second media identing information of the second PPM can be the same either because of duplicate wear or due to co-viewing. The first media identifying information of the first PPM and the second media identifying information of the second PPM, in other instances, can be different due to the first panelist and the second panelist consuming different media over the given time. The block 620 can receive the first media identifying information from the first PPM and the second media identifying information of the second PPM due to a transmission sent from the first PPM and the second PPM, respectively, over a network to the collections facility (such as the collections facility 110) of the AME. The block 620 can receive the first media identifying information associated with the first PPM and the second media identifying information of the second PPM from one or more databases (such as databases 145) at the same time or at different times. The block 620 can obtain the first media identifying information of the first PPM and the second media identifying information of the second PPM at a computing device such as the server 140 or the computing device 510. The block 620 can include determining the media associated with the first media identifying information of the first PPM and the media associated with the second media identifying information of the second PPM and can include associating the media as having been watched by someone with the demographics of the first panelist and the second panelist (e.g., the panelist profile data 508), respectively. The block 620 can occur prior to the block 615.

In some instances, the block 625 occurs after the block 615. In other instances, the block 625 occurs after the block 620. The block 620 can be implemented by the duplicate wear compliance module 512 of the computing device 510. The block 620 can be implemented by one or more servers of the AME. The block 620 can determine if duplicate wear of the first PPM and the second PPM occurred by comparing the motion sensing data from the first PPM for the period of time with the motion sensing data of the second PPM for the same period of time. The period of time can be 8 hours, 12 hours, 24 hours, and the like. The period of time can be set by the AME. For example, the period of time can correspond to when the first PPM is programmed to send the first set of motion sensing data and/or first media identifying information to the server(s) of the AME. The first set of motion sensing data of the first PPM and the second set of motion sensing data of the second PPM can be compared at the block 625 to determine if the first set of motion sensing data is the same or similar to (within a tolerance threshold such as 10%) to the second set of motion sensing data. If so, then the method 600 proceeds to the block 630. If not, then the method 600 proceeds to block 640.

In various aspects, the block 625 uses step detections (also referred to herein as “a number of steps”) as the first set of motion sensing data and the second set of motion sensing data for comparison to determine if duplicate wear of the first PPM and the second PPM occurred. The similarity of step detections between the first PPM and the second PPM for the period of time can indicate that duplicate wear of the first PPM and the second PPM occurred and is irrespective of the type of PPM or location of the PPM with respect to the panelist (e.g., whether the one of the PPMs was carried, while the other was worn). The block 625 can use a high step count for a subset of the period of time as the first set of motion sensing data and the second set of motion sensing data for comparison to determine if duplicate wear of the first PPM and the second PPM occurred. The similarity of high step counts for the subset of the period of time can indicate that duplicate wear of the first PPM and the second PPM occurred and is irrespective of the type of PPM or the location of the PPM with respect to the panelist (e.g., whether the first PPM was a smartphone and the second PPM was a wearable device on the panelist's wrist). For example, the high step counts for the subset of the period of time could indicate that the panelist is running, and it would be unlikely that two panelists would have the same number of step counts for the subset of the period of time unless they are the same panelist. The block 625 can also determine and/or compare the step rate per hour over the period of time for the first PPM and a step rate per hour over the period of time for the second PPM. The similarity of step rate per hour for the period of time can indicate that duplicate wear of the first PPM and the second PPM occurred and is irrespective of the type of PPM or the location of the PPM with respect to the panelist. The similarity of step detections, the similarity of high step counts for the subset of the period of time, and the similarity of step rate per hour can, in some instances, both be used to determine if duplicate wear occurred. In some aspects, if the similarity of step detections occurs, then the block 625 then determines if there is also a similarity of high step counts for the subset of the period of time and/or if there is also a similarity in step rate per hour. In other aspects, if the block 625 determines that there is a similarity of high step counts for the subset of the period of time, then the block 625 determines if there is also a similarity of step detections.

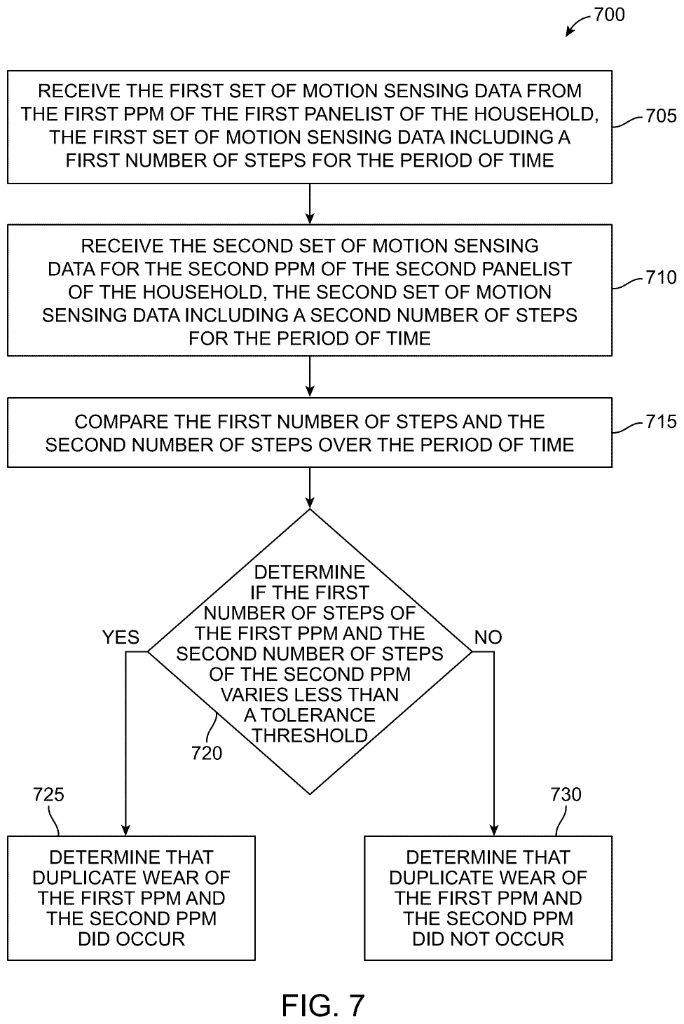

In one aspect, with continuing reference to block 625 of FIG. 6, turning now to FIG. 7, method 700 is a method for determining duplicate wear of the first PPM and the second PPM by the single panelist of the household using step detections is described. Method 700 is illustrated as a set of operations or blocks 705 through 730. Not all of the illustrated blocks 705 through 730 can be performed in all aspects of method 700. One or more blocks that are not expressly illustrated in FIG. 7 can be included before, after, in between, or as part of the blocks 705 through 730. In some aspects, one or more of the blocks 705 through 730 can be implemented, at least in part, by the computing device 300 and/or the server 140 in the form of executable code stored on non-transitory, tangible, machine-readable media that when run by one or more processors can cause the one or more processors to perform one or more of the processes. In one or more aspects, the blocks in method 700 are performed within a computing system and/or computing devices, as described herein.

The method 700 includes: receiving the first set of motion sensing data from the first PPM of the first panelist of the household, the first set of motion sensing data including a first number of steps for the period of time at a block 705; receiving the second set of motion sensing data for the second PPM of the second panelist of the household, the second set of motion sensing data including a second number of steps for the period of time at a block 710; comparing the first number of steps and the second number of steps over the period of time at a block 715; determining if the first number of steps of the first PPM and the second number of steps of the second PPM varies less than a tolerance threshold at a block 720; if so, then determining that duplicate wear of the first PPM and the second PPM did occur at a block 725; and if not, then determining that duplicate wear of the first PPM and the second PPM did not occur at a block 730.

In various aspects, the block 705 and the block 710 replace and/or supplement the blocks 615. In several aspects, the block 705 and/or the block 710 is at least a portion of the block 615. In some aspects, one or more of the blocks 710-730 replace and/or supplement the block 625. In one or more aspects, after the block 725 occurs, then the method 600 resumes and the block 630 occurs, or after the block 730 occurs, then the method 600 resumes, and the block 640 occurs.

In one or more aspects, the block 705 includes receiving the first set of motion sensing data and processing the first set of motion sensing data at a server of the AME to determine the first number of steps. For example, the first set of motion sensing data can be accelerometer data from the first PPM and can include an acceleration signal curve, where the peaks of the curve indicate movement, such as walking or running and troughs indicate no movement such as sitting. The acceleration signal curve can be used to detect the first number of steps. The first set of motion sensing data can be the first number of steps during the period of time (e.g., multiple, continuous hours). In other aspects, the block 705 includes receiving the first number of steps for the period of time from the first PPM. In yet other aspects, the block 705 includes receiving the first number of steps for the period of time from the first PPM stored in a database accessible by the AME (such as the first database 502).

In several instances, the block 710 includes receiving the second set of motion sensing data and processing the second set of motion sensing data at a server of the AME to determine the second number of steps. For example, the second set of motion sensing data can be accelerometer data from the second PPM and can include an acceleration signal curve, where the peaks of the curve indicate movement, such as walking or running and troughs indicate no movement such as sitting. The acceleration signal curve can be used to detect the second number of steps based on the number of peaks. In other aspects, the block 710 includes receiving the second number of steps for the period of time directly from the second PPM. In yet other aspects, the block 710 includes receiving the second number of steps for the period of time from the second PPM stored in a database accessible by the AME (such as the first database 502). The second set of motion sensing data can be the second number of steps during the period of time (e.g., multiple, continuous hours). The block 710 can occur simultaneously to the block 705. The block 710 can occur prior to the block 705.

In some instances, the first number of steps and the second number of steps are compared over the period of time by the duplicate wear compliance module 512. The comparison of the block 715 can be implemented by one or more servers (such as the server 140) or the computing device 510.

In one or more aspects, the block 715 occurs automatically with the block 720.

In various instances, the block 720 can include determining, based on the comparison, if the first number of steps of the first PPM and the second number of steps of the second PPM varies less than a tolerance threshold. The tolerance threshold can be 10%, 12%, 15%, or the like. For example, if the first number of steps over the period of time is 7232 steps over the 8-hour period, the second number of steps over the period of time is 2342 steps over the same 8-hour period, and the tolerance threshold is set at 10%, then, in this example, the method 700 would proceed to the block 730 because the variance is greater than 10%. However, in another example, if the first number of steps over the period of time is 6532 steps over 18 hours, the second number of steps is 6528 steps over 18 hours, and the threshold is 5%, then in this example, the method 700 would proceed to the block 725 because the variance is less than 5%.

In some aspects, the block 725 occurs automatically in response to the block 720.

In one or more aspects, the block 725 occurs automatically in response to the block 730.

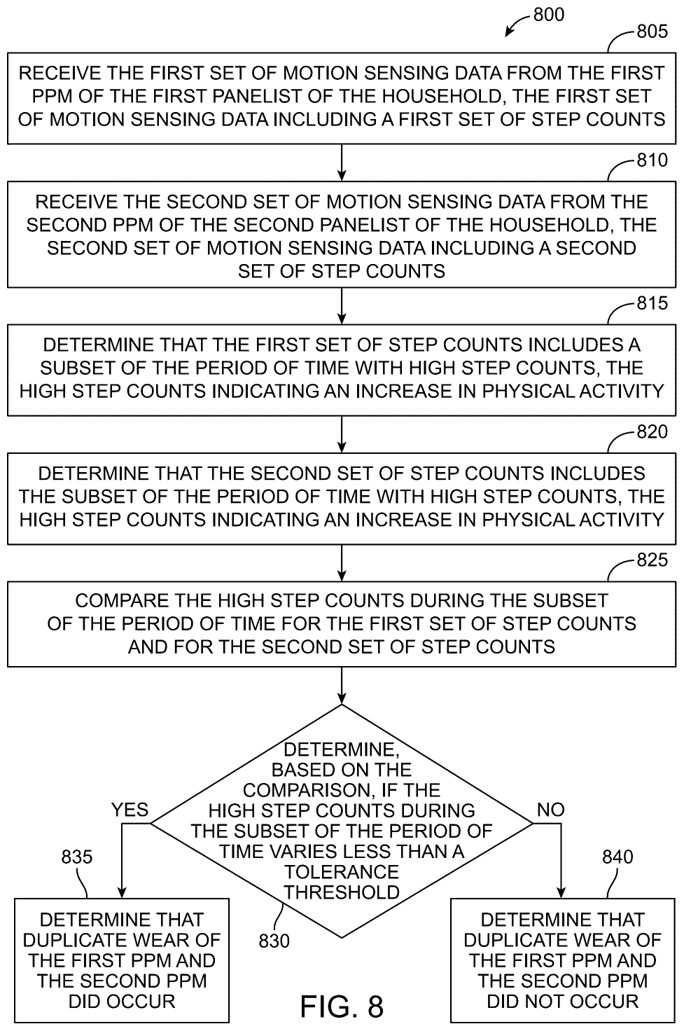

In one aspect, with continuing reference to block 625 of FIG. 6, turning now to FIG. 8, method 800 is a method for determining duplicate wear of the first PPM and the second PPM by the single panelist of the household using high step counts over a subset period of time is described. Method 800 is illustrated as a set of operations or blocks 805 through 840. Not all of the illustrated blocks 805 through 840 can be performed in all aspects of method 800. One or more blocks that are not expressly illustrated in FIG. 8 can be included before, after, in between, or as part of the blocks 805 through 840. In some aspects, one or more of the blocks 805 through 840 can be implemented, at least in part, by the computing device 300 and/or the server 140 in the form of executable code stored on non-transitory, tangible, machine-readable media that when run by one or more processors can cause the one or more processors to perform one or more of the processes. In one or more aspects, the blocks in method 800 are performed within a computing system and/or computing devices, as described herein.

The method 800 includes: receiving the first set of motion sensing data from the first PPM of the first panelist in the household, the first set of motion sensing data includes a first set of step counts at a block 805; receiving the second set of motion sensing data from the second PPM of the second panelist of the household, the second set of motion sensing data including a second set of step counts at a block 810; determining that the first set of step counts includes a subset of the period of time with high step counts, the high step counts indicating an increase in physical activity at a block 815; determining that the second set of step counts includes the subset of the period of time with high step counts, the high step counts indicating an increase in physical activity at a block 820; comparing the high step counts during the subset of the period of time for the first set of step counts for the second set of step counts at a block 825; determining, based on the comparison, if the high step counts during the subset of the period of time varies less than a tolerance threshold at a block 830; if so, then determining that duplicate wear of the first PPM and the second PPM did occur at a block 835; and if not, then determining that duplicate wear of the first PPM and the second PPM did not occur at a block 840.

In some instances, the blocks 805 and/or 810 replace and/or supplement the blocks 705 and 710 and/or the block 615.

In several aspects, the block 805 is at least a portion of the block 615. In one or more aspects, the block 805 includes receiving the first set of motion sensing data and processing the first set of motion sensing data at a server of the AME to determine the first set of step counts. Step counts can be referred to herein as a number of steps. For example, the first set of motion sensing data can be accelerometer data from the first PPM and can include an acceleration signal curve, where the peaks of the curve indicate movement, such as walking or running and troughs indicate no movement such as sitting. The acceleration signal curve can be used to detect the first set of step counts. The first set of motion sensing data can be the first set of step counts during the period of time (e.g., multiple, continuous hours). In other aspects, the block 805 includes receiving the first set of step counts for the period of time from the first PPM. In yet other aspects, the block 805 includes receiving the first set of step counts for the period of time from the first PPM stored in a database accessible by the AME (such as the first database 502).

In several aspects, the block 810 is at least a portion of the block 615. In one or more aspects, the block 810 includes receiving the second set of motion sensing data and processing the second set of motion sensing data at a server of the AME to determine the second set of step counts. Step counts can be referred to herein as a number of steps. For example, the second set of motion sensing data can be accelerometer data from the second PPM and can include an acceleration signal curve, where the peaks of the curve indicate movement, such as walking or running and troughs indicate no movement such as sitting. The acceleration signal curve can be used to detect the second set of step counts. The second set of motion sensing data can be the second set of step counts during the period of time (e.g., multiple, continuous hours). In other aspects, the block 810 includes receiving the second set of step counts for the period of time from the second PPM. In yet other aspects, the block 810 includes receiving the second set of step counts for the period of time from the second PPM stored in a database accessible by the AME (such as the first database 502).

In one or more instances, the block 815 occurs to determine that within the period of time, there is a subset of the period of time with high step counts for the first set of step counts. The high step counts indicating an increase in physical activity such as walking, jogging, or running. The high step counts can be determined by looking at the acceleration signal curve for the number of peaks (indicating physical activity). For example, the more peaks in the subset of the period of time, the greater the physical activity. The high step count can be determined based on a set number of peaks over a set period of time. For example, 1,500 peaks in a 7 min period may indicate that a panelist went for a mile run. The 1,500 peaks would indicate the step count. Another example of high step counts would be 240-280 peaks per minute if the panelist was a world-class sprinter. In some instances, the high step count is determined by the first PPM rather than at a server of the AME, and the AME uses the determined high step counts at the block 815. The AME could assign a value of what is considered high step counts (e.g., 200 steps per minute). Alternatively, the first PPM could assign a value of what is considered high step counts (e.g., 240 steps per minute). The first PPM could also include and/or be operably coupled to a medical sensor such as, but not limited to, a heart rate monitor, an electrochemical sensor, and/or an optical sensor to measure perspiration that is used in conjunction with the step counter (such as the motion sensor 430) to determine high step counts. The block 815 can determine a single high step count event or multiple high step count events (e.g., a first subset of the period of time with high step counts and a second subset of the period of time with high step counts).

In some instances, the block 820 occurs in response to the block 815. For example, if the block 820 instead determined that no high step counts occurred then the method 800 would end. The block 820 occurs to determine that within the period of time, there is a subset of the period of time with high step counts for the second set of step counts. The high step counts indicating an increase in physical activity such as walking, jogging, or running. The high step counts can be determined by looking at the acceleration signal curve for the number of peaks (indicating physical activity). For example, the more peaks in the subset of the period of time, the greater the physical activity. The high step count can be determined based on a set number of peaks over a set period of time. For example, 2000 peaks in a 10 min period may indicate that a panelist went for a mile run. The 2000 peaks would indicate the step count. In some instances, the high step count is determined by the second PPM rather than at a server of the AME, and the AME uses the determined high step counts at the block 820. The AME could assign a value of what is considered high step counts (e.g., 180 steps per minute). Alternatively, the second PPM could assign a value of what is considered high step counts (e.g., 250 steps per minute). The second PPM could also include and/or be operably coupled to a medical sensor such as but not limited to, a heart rate monitor, an electrochemical sensor, and/or an optical sensor to measure perspiration that is used in conjunction with the step counter (such as the motion sensor 430) to determine high step counts. The block 820 can determine a single high step count event or multiple high step count events (e.g., a first subset of the period of time with high step counts and a second subset of the period of time with high step counts).

In various instances, the block 820 occurs prior to block 815. The block 815 can occur in response to the block 820.

In several aspects, the block 825 occurs in response to the block 815 and/or the block 820. One or more of the blocks 825-840 form at least a portion of the block 625. One or more of the blocks 825-840 replace or supplement the block 625.

In one or more aspects, the block 825 compares the high step counts during the subset of the period of time for the first step counts and for the second set of step counts using the duplicate wear compliance module 512. The comparison of the block 825 can be implemented by one or more servers (such as the server 140) or the computing device 510. The block 825 can compare multiple high step count events corresponding to the same subset of period of time. The block 825 can occur automatically with the block 830.

In one or more aspects, the block 830 occurs automatically in response to the block 825. The block 830 can include determining if the high step counts during the subset of the period of time of the first set of step counts and the high step counts during the subset of the period of time (the same subset of time) varies less than a tolerance threshold. The tolerance threshold can be the same or different to the tolerance threshold in FIG. 7. The tolerance threshold can be 5%, 10%, 12%, or the like. For example, if the first set of step counts of the first PPM show a high step count event (4,121 steps over a 45 min period at time 2:05 pm to 2:45 pm) and the second set of step counts of the second PPM show a high step count event (4,020 steps over a 45 min period at time 2:05 to 2:45), with a threshold tolerance at 10%, then the method 700 would proceed to the block 835, since the high step counts of the first PPM and the second PPM vary less than the tolerance threshold, indicating similarity. However, in another example, if the first set of step counts of the first PPM show a high step count event (95 steps/min over a 60 min period at time 1:05 pm to 2:05 pm) and the second set of step counts of the second PPM show a high step count event (50 steps/min over a 60 min period at time 1:05 pm to 2:05 pm), with a threshold tolerance at 10%, then the method 700 would proceed to the block 840, since the high step counts of the first PPM and the second PPM vary greater than the 10% tolerance threshold.

In various aspects, the block 835 occurs in response to determining that the high step counts from the first PPM and the high step counts from the second PPM vary less than the tolerance threshold, indicating that duplicate wear of the first PPM and the second PPM did occur. In some instances, multiple matches of high step counts over various subsets of the period of time are needed in order to proceed to the block 835. The block 835 can proceed to the block 630.

In some aspects, the block 840 occurs in response to determining that the high step counts from the first PPM and the high step counts from the second PPM vary more than the tolerance threshold, indicating that duplicate wear of the first PPM and the second PPM did not occur. The block 840 can proceed to the block 640.

Returning now to FIG. 6, with continuing reference to FIGS. 1-5 and 7-8, the block 625 determines, using the first and the second set of motion sensing data, if duplicate wear of the first PPM and the second PPM occurred using at least a portion of the method 700 or the method 800. In some instances, the method 700 and the method 800 are both used in the method 600.

In some aspects, an additional block occurs prior to the block 630. The additional block uses location data from the first PPM and/or the second PPM from the period of time. The location data can be used to validate that duplicate wear occurred. In some aspects, location data is unavailable, and this block is omitted.

In some aspects, the block 630 occurs in response to the block 625 determining that duplicate wear did occur. The block 630 can occur automatically in response to the block 625. The block 630 can report non-compliance by flagging a particular dataset (such as a day) as non-compliant for the household. In some instances, an additional block can be provided that determines which panelist of the household wore and/or carried the first PPM and the second PPM. In this example, the non-compliance of a particular panelist would be reported. The block 630 can be implemented by the report generator module 514 and generate the report 516. The block 630 can flag a household or a panelist of the household (e.g., the first panelist) for re-training on proper PPM handling or flag a household for removal from the panel. The block 630 can send a report of non-compliance to the AME and the AME can communicate with the household regarding the flag of non-compliance due to duplicate wear.

In one or more instances, the block 635 occurs after the block 630 and/or the block 625. The block 635 uses timestamps related to the motion sensing data to compare to timestamps associated with media identifying information to remove the media identifying information for the overlapping time (“the period of time”) from crediting. In some instances, both the media identifying information associated with the first PPM and the media identifying information associated with the second PPM is removed from crediting. If the additional block determines which panelist was non-compliant, then the method 600 can include removing the media identifying information for the other panelist. For example, if the first panelist is wearing the first PPM and the second PPM, then the method 600 could remove the media identifying information associated with the second PPM and only credit the media identifying information associated with the first PPM.

In some instances, the method 600 includes an additional block that validates the non-compliance by comparing the media identifying information associated with the first PPM and the media identifying information associated with the second PPM for the period of time to determine if the underlying media and timestamps are similar (including a tolerance threshold).

In various aspects, the block 625 proceeds to the block 640 when a determination is made using the first and the second set of motion sensing data that duplicate wear did not occur. If duplicate wear did not occur, the media is credited. The media identifying information of the first PPM and the media identifying information of the second PPM from the block 620 is used to credit the media. Crediting media can also include using panelist demographic information (such as panelist profile data 508 from the second database 504) to credit the media as having been watched by a person with demographics of the first panelist and/or the demographics of the second panelist. The media can include a plurality of media contents consumed by the first panelist identified by the media identifying information associated with the first PPM and can include a plurality of media contents consumed by the second panelist identified by the media identifying information associated with the second PPM. The media for crediting can be completely different between the two panelists, or at least a portion of the media can be the same between the two panelists, which is referred to as co-viewing.

### IV. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

It is also understood that the exemplary division and relationship between the modules shown in the Figures above can be modified without departing from the scope or spirit of the present invention. Additionally, function can be distributed across several modules.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A method for determining duplicate wear comprising:
receiving a first set of motion sensing data associated with a first portable people meter (“PPM”) associated with a first panelist of a household, the first set of motion sensing data including a first number of steps over a period of time;
receiving a second set of motion sensing data associated with a second PPM associated with a second panelist of the household, the second set of motion sensing data including a second number of steps over the period of time;
comparing the first number of steps and the second number of steps over the period of time;
determining that the first number of steps of the first PPM and the second number of steps of the second PPM vary less than a tolerance threshold; and
based on the first number of steps of the first PPM and the second number of steps of the second PPM varying less than the tolerance threshold, determining that duplicate wear of the first PPM and the second PPM occurred.

2. The method of claim 1, further comprising:
flagging the duplicate wear over the period of time as non-compliant.

3. The method of claim 1, further comprising:
removing the household from a panel of an audience measurement entity after the determining that duplicate wear of the first PPM and the second PPM occurred.

4. The method of claim 1, wherein the first set of motion sensing data is accelerometer data from the first PPM.

5. The method of claim 4, wherein the accelerometer data includes an acceleration signal curve over the period of time, wherein peaks of the acceleration signal curve indicate physical activity, and wherein the peaks correspond to the first number of steps.

6. The method of claim 4, wherein the accelerometer data of the first PPM is sampled at a rate between 15 and 20 Hz.

7. A non-transitory computer-readable storage medium, having stored thereon program instructions that, upon execution by a processor, cause performance of a set of operations comprising:
obtaining a first set of motion sensing data associated with a first portable people meter (“PPM”) associated with a first panelist of a household, the first set of motion sensing data including a first number of steps over a period of time;
obtaining a second set of motion sensing data associated with a second PPM associated with a second panelist of the household, the second set of motion sensing data including a second number of steps over the period of time;
comparing the first number of steps and the second number of steps over the period of time;
determining that the first number of steps of the first PPM and the second number of steps of the second PPM vary less than a tolerance threshold; and
based on the first number of steps of the first PPM and the second number of steps of the second PPM varying less than the tolerance threshold, determining that duplicate wear of the first PPM and the second PPM occurred.

8. The non-transitory computer-readable storage medium of claim 7, the set of operations further comprising:
obtaining a first set of media identifying information from the first PPM over the period of time; and
obtaining a second set of media identifying information from the second PPM over the period of time.

9. The non-transitory computer-readable storage medium of claim 8, the set of operations further comprising:
removing at least one of the first set of media identifying information or the second set of media identifying information from crediting based on the determining that duplicate wear of the first PPM and the second PPM occurred.

10. The non-transitory computer-readable storage medium of claim 7, wherein the second set of motion sensing data is accelerometer data from the second PPM.

11. The non-transitory computer-readable storage medium of claim 10, wherein the accelerometer data includes an acceleration signal curve over the period of time, wherein peaks of the acceleration signal curve indicate physical activity, and wherein the peaks correspond to the second number of steps.

12. A computing system comprising:
a processor; and
a non-transitory computer-readable storage medium, having stored thereon program instructions that, upon execution by the processor, cause performance of a set of operations comprising:
obtaining a first set of motion sensing data associated with a first portable people meter (“PPM”) associated with a first panelist of a household, the first set of motion sensing data including a first number of steps over a period of time;
obtaining a second set of motion sensing data associated with a second PPM associated with a second panelist of the household, the second set of motion sensing data including a second number of steps over the period of time;
comparing the first number of steps and the second number of steps over the period of time;
determining that the first number of steps of the first PPM and the second number of steps of the second PPM vary less than a tolerance threshold; and
based on the first number of steps of the first PPM and the second number of steps of the second PPM varying less than the tolerance threshold, determining that duplicate wear of the first PPM and the second PPM occurred.

13. The computing system of claim 12, wherein the first PPM is an application on a mobile device.

14. The computing system of claim 13, wherein the second PPM is a wearable meter.

15. The computing system of claim 12, the set of operations further comprising:
determining that at least one of the first panelist or the second panelist of the household is non-compliant with a panel of an audience measurement entity.

16. The computing system of claim 15, the set of operations further comprising:
outputting a report based on the at least one of the first panelist or the second panelist of the household being non-compliant.

17. The computing system of claim 12, wherein the period of time is multiple hours.

18. The computing system of claim 17, wherein the first panelist and the second panelist are panelists on a panel for an audience measurement entity, the panel designed to measure media consumption of the first panelist and the second panelist, respectively, and to associate demographics of the first panelist and the second panelist with the media consumption.

19. The computing system of claim 17, wherein the first set of motion sensing data includes accelerometer data from the first PPM.

20. The computing system of claim 19, wherein the accelerometer data is used to determine the first number of steps.
